(19) United States
(12) Patent Application Publication
(10) Pub. No.: US 2006/0103136 A1
(43) Pub. Date: May 18, 2006

(54) Pipe coupling and method

(76) Inventors: Theodore H Krengel, Flossmoor, IL (US); Curtis R Brown, Crete, IL (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/521,481

(22) PCT Filed: Jul. 24, 2003
(86) PCT No.: PCT/US03/23144

§ 371 Date: Sep. 1, 2005

Related U.S. Application Data
(60) Provisional application No. 60/398,698, filed on Jul. 26, 2002.

(51) Int. Cl. F16L 23/00

(52) U.S. Cl. 285/371

(57) ABSTRACT

A pipe coupling including coaxially aligned pipes (24), an internal tubular metal sleeve (20) having opposed ends press-fit into the open ends of the pipes, channel-shaped grooves (28) rolled into an outside diameter of each of the pipes and the sleeve (20), and a U-shaped circular metal housing (40) having leg portions (42) received in the grooves (28), retaining the pipes in coaxial alignment. The method includes press-fitting the opposed ends of the sleeve into the pipes, rolling a channel-shaped groove (28) into the pipes (24) and the sleeve (20), and assembling the legs (42) of the housing (40) in the grooves (28).

### FIELD OF THE INVENTION

The present invention relates to pipe or tube couplings used to join coaxially aligned, nearly abutting tubes or pipes wherein the pipes include a rolled groove adjacent the opposed ends of the pipes which receive a clamp band, such as a conventional bolt clamp having a U-shaped cross section and generally including a gasket located within the clamp housing.

### BACKGROUND OF THE INVENTION

Numerous types of couplings are commercially available to join coaxially aligned tubes or pipes to transmit fluid including gas and liquid through the pipes. One conventional type includes rolled grooves adjacent the opposed ends of the pipes and the pipes are joined by a housing comprised of two identical C-shaped halves which are U-shaped in cross-section, each having radially extending ears which are bolted together and a gasket is received within the U-shaped housing sealing the joint. The circular end portions or legs of the U-shaped cross-section of the housing are then received in the grooves and the halves are bolted together to form a joint or coupling. Both thick or heavy wall pipes and light wall pipes can be roll grooved wherein the outside diameter is cold formed towards the inside of the tube but spaced from the ends of the pipes. As used herein, the terms pipe and tube are intended to be synonymous, except where dimensions are provided.

For example, the nominal outside diameter of 2″ sprinkler pipe is 2.375 inches. In a Schedule 40 pipe of this diameter, the wall thickness is 0.154 inches. As the wall thickness decreases, the capacity for pressure rating decreases. For example, with one known pipe, the wall thickness is 0.080″, and the pressure rating is 300 psi. A second pipe made by the same manufacturer has a wall thickness of 0.65″, and the pressure rating is 175 psi. In order to accommodate a water pressure of 300 pounds, the wall thickness of the pipe must be increased from 0.065 inches to 0.080 inches to meet the Deflection or Bend Test used by Factory Mutual (FM), Underwriters Laboratories (UL) described further below and other standards.

### SUMMARY OF THE INVENTION

The method of this invention avoids the problems associated with the prior art wall thickness limitations described above. Although the method of this invention has particular advantages for sprinkler pipe, the method of this invention may be utilized in any application where roll grooving and the grooved fittings are used, as well as for different types of pipe materials such as stainless steel, copper, aluminum, etc. The method of this invention may be used with pipe having a protective coating, such as galvanized pipe, without destroying the protective metal coating. The method of this invention may also be used to form a coupling at the site using conventional equipment.

The method of forming a fluid tight coupling between coaxially aligned metal pipes of this invention first includes inserting a metal sleeve into the open ends of each of the metal pipes to be joined. In the preferred embodiment, the sleeves have an outside diameter generally equal to an inside diameter of the pipes to be joined, preferably forming a press fit, and the thickness of the sleeves are designed as necessary to meet a specific pressure requirement. For example, using the above scenario, using the 0.065″ wall @ 175 psi, a spacer of “X” thickness is used to achieve a 300 psi rating. A spacer of “Y” thickness could be used to achieve a pressure rating of 450 psi. Ultimately, the goal of the sleeve is to eliminate the grooved connection from being the weakest link in a bend test and has advantages in the other tests and standards required for certification. The press fit may be accomplished by tapering the sleeve, such that the smaller diameter portion is first received in the open end of the pipe or the pipe may be heated and/or the sleeve may be cooled prior to assembly to form a press fit. In many applications, it would be desirable to form a fluid-tight seal between the pipes to be joined and the sleeve. This can be accomplished by using a sleeve having tapered end portions wherein the major diameter is slightly greater than the internal diameter of the pipe and using a press to force the sleeve into the pipe and form a fluid-tight seal between the sleeve and the pipe or a die may be utilized to expand the sleeve following insertion.

A groove is then rolled into the outside diameter of the pipes adjacent to but spaced from the open end of each of the pipes, wherein the groove extends into the sleeve, locking the sleeve in the pipe. In the most preferred embodiment, the groove is generally rectangular, forming a generally rectangular groove in the sleeve and permanently locking the sleeve in the pipe. As used herein, “generally rectangular” means that the general shape of the grooves are rectangular but preferably include rounded corners or fillets at the corners formed during the rolling process. Other forms of grooves may be used. In the most preferred embodiment, the sleeve has an open end aligned with the open end of the pipe and extends into the pipe about three inches or less, most preferably about two inches, but the length will depend upon the application.

The pipes are then joined by a generally circular housing as is conventional with pipe couplings of this type. The housing is U-shaped in cross-section, including leg portions which are received within the grooves in the outside diameter of the pipes, retaining the pipes in coaxially aligned relation. That is, the housing may be comprised of two identical semicircular halves, for example, each including opposed radially extending ears and the ears are secured together by bolts, sometimes referred to as bolt clamps or bolted clamp bands. A circular seal or gasket is preferably received around the adjacent opposed ends of the pipes, which is then received within the U-shaped cross-section of the housing components during assembly as is conventional with fire sprinkler systems of this general type. The pipes and the sleeve may be coated with a protective metal coating, such as a galvanized coating, and the method of forming a coupling of this invention does not disturb the coating, thereby reducing the likelihood of rust. The coupling and method of this invention substantially increases the strength of the coupling under a bending load as described below, without requiring an increased thickness of the pipe substantially reducing the overall cost. The coupling and method of this invention also meet or exceeds the other standards required for certification. Under the deflection or bend test required for sprinkler pipe, a load is applied to the coupling housing while the pipe is maintained under pressure. A conventional rolled groove coupling fails under static load because the pipe flexes at the rolled groove on one or both sides of the coupling. The pipe coupling of this invention substantially increases the strength of the coupling under the deflection or bend test required for certification of sprinkler pipe at a predetermined pressure. Other advantages and meritorious features of the coupling and method of this invention will be more fully understood from the following description of the preferred embodiments, the appended claims and the drawings, a brief description of which follows.

### BRIEF DESCRIPTION OF THE DRAWINGS

FIG. 1 is a cross-sectional side view of one open end of a pipe and a sleeve for receipt in the open end of the pipe;

FIG. 2 is a side cross-sectional view of FIG. 1 after receipt of the sleeve in the open end of the pipe;

FIG. 3 is a side cross-sectional view of the open end of the pipe following rolling of a groove into the outside diameter of the pipe and into the sleeve adjacent to, but spaced from the open end of the pipe;

FIG. 4 is a partial side cross-sectional view of the rolling step;

FIG. 5 illustrates an alternative embodiment, wherein the sleeve is tapered; and

FIG. 6 illustrates a preferred embodiment of a coupling formed by the method of this invention during a deflection or bend test of the type required for sprinkler pipe.

### DESCRIPTION OF THE PREFERRED EMBODIMENTS

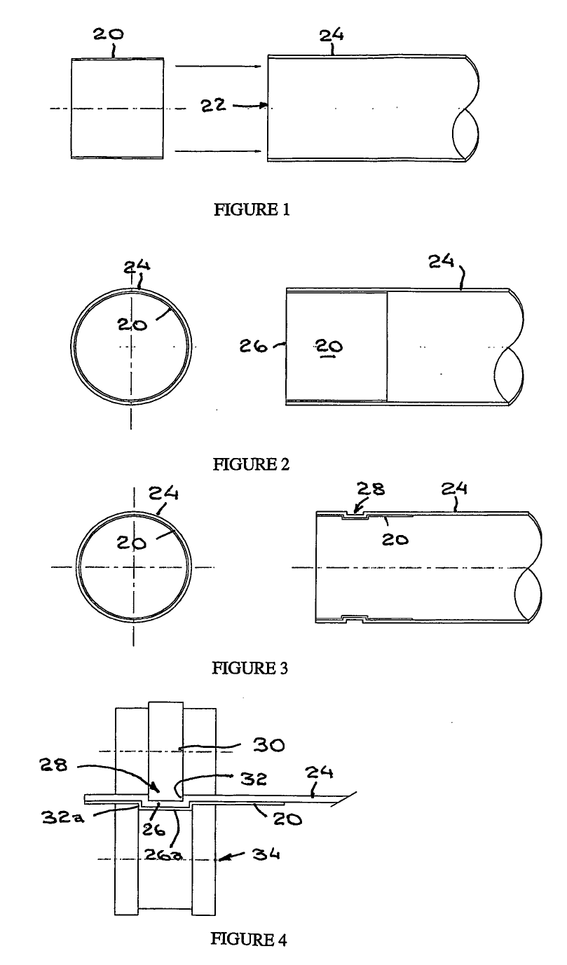

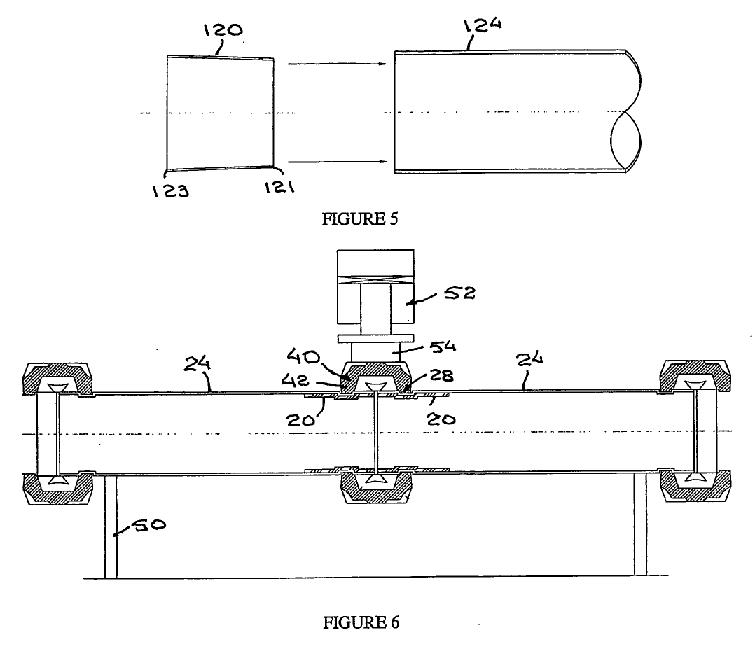

FIGS. 1 and 2 illustrate the first step of forming a coupling of this invention, wherein a sleeve 20 is inserted into the open end 22 of each of the pipes 24 to be joined. As best shown in FIG. 2, the outside diameter of the sleeve 20 is preferably equal to the inside diameter of the pipe 24, forming a press fit, preferably a fluid-tight seal between the sleeve 20 and the pipes 24. This can be accomplished in several ways. For example, the outside diameter of the sleeve 20 may be equal to the inside diameter of the pipe 24 and cooled in dry ice, for example, reducing the diameter of the sleeve 20, and/or the pipe 24 may be heated to increase the inside diameter of the pipe 24. Where the pipe 24 includes a protective metal coating, such as zinc or a galvanized coating, the pipe is preferably heated to a temperature less than the melting temperature of the protective metal coating. Alternatively, as described below in regard to FIG. 5, the sleeve may be slightly tapered or frustoconical. Where the ends of the sleeve 20 are tapered or frustoconical, the major diameter may be greater than the inner diameter of the pipes 24 and the sleeve forced into the pipes by a suitable press. Alternatively, a die member may be utilized to expand the sleeve following insertion to form a fluid-tight seal between the sleeve and the pipes. Although a press fit of the sleeve 20 in the pipe 24 is preferred, it is not essential to the method of this invention. In the preferred embodiment, the open end 26 of the sleeve 20 is aligned with the end of the pipe 24 as shown in FIG. 2.

The next step in the method of forming a coupling of this invention is to roll a groove 28 into the outside diameter of the pipe 24 as shown in FIGS. 3 and 4. Although the groove 28 may be formed by any conventional method, the groove is preferably formed by a roller such is shown at 30 in FIG. 4 which forms a generally rectangular groove having side walls 32 and a bottom wall 36 and formed against a backup roller 34 located within the pipe. The liner 20 is thus formed by the roller 30 and backup roller 34 into the configuration of the groove 28, including side walls 32a and bottom wall 36a, generally identical to the groove 28 in the pipe 24, forming a mechanical interlock between the pipe 24 and the liner 20. As will be understood, the liner 20 strengthens the joint shown in FIG. 6 under a bending load, as discussed further below.

FIG. 5 illustrates an alternative embodiment of the coupling and method of this invention, wherein the sleeve 120 is slightly tapered or frustoconical and wherein the smaller diameter end 121 has an outer diameter smaller than the internal diameter of the pipe 124 and a major diameter 123 which is equal to the internal diameter of the pipe 124. As will be understood, a tapered sleeve 120 is easier to insert into the pipe 124 and no heating or cooling is required to form a press fit. The taper of the sleeve 120 has been exaggerated in FIG. 5 for clarity.

FIG. 6 illustrates a completed coupling and the deflection or bend test used to test the strength of a sprinkler system pipe and coupling, as now described. The coupling is completed by a generally circular housing 40, which is U-shaped in cross-section as shown in FIG. 6, including leg portions 42 which are received in the rolled grooves 28 and a conventional gasket 44 is received around the open ends 22 of the pipes 24 within the U-shaped housing 40. Housings and gaskets of the type illustrated in FIG. 6 are commercially available from various sources, including Victaulic of Easton, Pa. A typical housing 40 of the type shown in FIG. 6 is formed of two identical semicircular halves, each of which includes radially extending ears (not shown) and the ears include aligned openings which receive a bolt and the bolts are retained by conventional nuts. The gasket 44 may be formed of any suitable material including elastomeric materials, such as rubber or synthetic rubber, or various polymers. The housing 40 is typically formed of steel but may be formed of various metals and may be coated with a protective metal coating, such as zinc.

FIG. 6 also illustrates the deflection or bend test used by Factory Mutual (FM), Under Laboratories (UL) and other certification laboratories for the coupling used in fire protection sprinkler systems. In such tests, the pipe 24 on opposed sides of the coupling is supported in a saddle 50 and a load is applied by a hydraulic cylinder 52 having a load cell 54. The pipe 24 is filled with water under pressure during the deflection or bend test and the pipe and coupling is then rated for use in sprinkler systems. It is important to emphasize, however, that the coupling of this invention meets or exceeds the other tests and standards required for certification.

As will be understood, as the wall thickness of the tube decreases, the strength of the pipe also decreases. For example, a Schedule 5 pipe cannot be tested for or presently given a pressure rating greater than 175 psi according to Factory Mutual using the prior art rolled groove coupling described above. However, with the addition of the sleeve or liner 20 formed by the method of this invention, the coupling will withstand 300 psi or nearly double the pressure rating of a conventional coupling of this type having the same wall thickness. The pipe 24 in the prior art coupling and the present invention will have a conventional outside diameter, but may have a greater inside diameter for the same pressure rating, thereby significantly reducing the overall cost and weight of the pipe used in sprinkler systems, further reducing shipping costs. Similar advantages are achieved for other applications. Although the dimensions of the pipe and the groove will depend upon the application and the pressure rating desired, a typical sprinkler pipe will have a nominal two inch outside diameter (2.375 in.), wherein the rolled groove is located about 0.625 in. from the open end 22 of each pipe and the rolled groove has a width of 0.344 in. The length of the sleeve 20 is preferably about three inches, most preferably about two inches.

As will be understood, the method of forming a coupling and coupling of this invention may be modified within the purview of the appended claims. The pipe 24 is preferably formed of steel and most preferably includes a protective metal coating, such as zinc. However, similar advantages are achieved for pipe made of other materials. The sleeve 20 is preferably formed of the same metal as the pipe 24 and preferably also includes a protective metal coating at least on the inner diameter of the sleeve. The groove 28 is preferably rectangular (as described above) to receive the rectangular legs 42 of the housing 40, but other shapes and grooves may also be utilized. Having described the preferred embodiments of the coupling and method of forming same of this invention, the invention is now claimed as follows.

1. A method of forming a fluid tight coupling between the end portions of coaxially aligned metal pipes, comprising the following steps, performed in sequence:
inserting a metal sleeve into the open ends of each of said metal pipes to be joined;
rolling a groove into an outside diameter of each of said pipes adjacent to but spaced from the open ends of each of said pipes, wherein said groove extends into said sleeve, locking said sleeve in said pipe; and
forming a coupling between said pipes by receiving a generally circular housing having a U-shaped cross-section including leg portions received within said grooves retaining said pipes in coaxially aligned relation.

2. The method of forming a fluid tight coupling as defined in claim 1, wherein said method includes rolling a generally rectangular groove in said outside diameter of each of said pipes and said sleeves.

3. The method of forming a fluid tight coupling as defined in claim 1, wherein said method includes inserting a metal sleeve into the open ends of said metal pipes formed of the same metal as said pipes.

4. The method of forming a fluid tight coupling as defined in claim 1, wherein said method includes inserting a metal sleeve into the open ends of said metal pipes having a thickness equal to or less than said metal pipes.

5. The method of forming a fluid tight coupling as defined in claim 4, wherein said method includes inserting a metal sleeve into the open ends of said metal pipes having a thickness substantially less than said metal pipes.

6. The method of forming a fluid tight coupling as defined in claim 1, wherein said method includes inserting a metal sleeve into the open ends of said metal pipes having an outside diameter generally equal to and inside diameter of said pipes forming a press fit.

7. The method of forming a fluid tight coupling as defined in claim 1, wherein said method includes cooling said metal sleeve prior to inserting said metal sleeve into said open ends of said metal pipes to reduce the outside diameter of said sleeves and form a press fit.

8. The method of forming a fluid tight coupling as defined in claim 1, wherein said method includes heating said metal pipes to increase the inside diameter of said pipes prior to inserting said metal sleeve to form a press fit.

9. A coupling between opposed ends of coaxially aligned metal pipes, each of said metal pipes including an internal metal sleeve having an outside diameter generally equal to an inside diameter of said pipes, a groove rolled into an outside diameter of each of said pipes adjacent to but spaced from said opposed ends of said pipes, said grooves extending into said sleeves and locking said sleeves in said pipes, and a generally circular metal housing having a U-shaped cross-section including leg portions received within said grooves retaining said pipes in coaxially aligned relation.

10. The coupling between opposed ends of coaxially aligned pipes as defined in claim 7, wherein said grooves in said pipe and said sleeve are generally rectangular in cross-section.

11. The coupling between opposed ends of coaxially aligned pipes as defined in claim 7, wherein said sleeves are formed of the same metal as said pipes.

12. The coupling between opposed ends of coaxially aligned metal pipes as defined in claim 7, wherein said sleeves have a thickness as necessary to achieve required strength of said pipes.

13. The coupling between opposed ends of coaxially aligned metal pipes as defined in claim 7, wherein said sleeves are press fit into an open end of said pipes.

14. The coupling between opposed ends of coaxially aligned metal pipes as defined in claim 7, wherein said pipes and said sleeves are formed of steel (but not limited to).
